(19) United States
(12) Patent Application Publication
(10) Pub. No.: US 2009/0236902 A1
(43) Pub. Date: Sep. 24, 2009

(54) Spoked Bicycle Wheel

(76) Inventor: Mordecai Zibkoff, Brooklyn, NY (US)

Correspondence Address: HOFFMANN & BARON, LLP, 6900 JERICHO TURNPIKE, SYOSSET, NY, 11791, US

(21) Appl. No.: 12/400,043

(22) Filed: Mar. 9, 2009

Related U.S. Application Data
(60) Provisional application No. 61/038,444, filed on Mar. 21, 2008.

(51) Int. Cl. B60B 5/00

(52) U.S. Cl. 301/104

(57) ABSTRACT

A wheel including a rim, hub and at least one spoke, is disclosed. The spoke of the wheel has a leading edge with an aerodynamic protrusion and a valley. Also disclosed is a method of reducing aerodynamic drag on a wheel. According to the method, airflow around an aerodynamic protrusion disposed on a leading edge of a spoke of the wheel is disrupted into a plurality of airflows forming a first vortex about a first valley associated with the protrusion and a second vortex about a second valley associated with the protrusion. The plurality of airflows are joined at the trailing edge of the spoke.

### CROSS REFERENCE TO RELATED APPLICATION

This application claims the benefit of U.S. Provisional Application No. 61/038,444, filed on Mar. 21, 2008, the disclosure of which is incorporated herein by reference.

### BACKGROUND OF THE INVENTION

1. Field of Invention

This invention relates to bicycle wheels and more precisely to the spokes of aerodynamic bicycle wheels.

2. Background of the Related Art

Cycling has served many purposes in human history. From construction of a bicycle, to the first recorded road race in 1868, bicycle riding has extended beyond its functional purpose of transportation. In 1900 Belgium, France, Italy, Switzerland, and the United States founded the International Cycling Union (UCI). This Union still functions today, hosting road bicycle races world wide and promoting all forms of cycling.

Recent years have seen the popularity of road bicycle races skyrocket, with racers, such as Lance Armstrong, becoming icons of American popular culture. Cycling has become more popular at all levels, from adult weekend athletes, to dirt bike riders, and even to children's bicycle riding.

While much of the bicycle structure (e.g. two wheels, handle bars, gears, breaking mechanism) has remained consistent, the materials from which these parts are constructed and the detailed design have changed. These changes have led to lighter weight bicycles with aerodynamic shapes.

The aerodynamic nature of a bicycle is somewhat inhibited by the rider, who blocks much of the airflow. A secondary and more malleable portion of the bicycle, which creates wind resistance, is the wheel.

A typical bicycle wheel can have up to 32 spokes in certain double crossing configurations, and while these more traditional bicycle wheels typically have rounded spokes, the spokes can be made in an elliptical or bladed shape for the purposes of aerodynamics or aesthetics.

Various aerodynamic wheels have been developed for bicycle racing. These include, for example, wheels having no spokes, such as disc wheels; wheels having very few spokes, such as the Hed 3 manufactured by Hed; and wheels having many bladed spokes such as the Stinger or Jet 50 manufactured by Hed or the Ksyrium-SL-Premium manufactured by Mavic.

U.S. Pat. No. 5,080,444 to Hopkins et al. (Hopkins) discloses spokes with a leading and trailing edge. These spokes are aerodynamically shaped, having a width to thickness aspect ratio greater than 3.0.

U.S. Pat. No. 6,086,161 to Luttgeharm et al., (Luttgeharm) discloses a wheel, with at least one spoke, where the cross section of the spoke varies from first to second end. Luttgeharm does not disclose any surface features on the spokes.

U.S. Pat. No. 5,246,275 to Arredondo Jr. (Arredondo), entitled Wheel for Bicycles and Method of Producing, discloses the use of aerodynamic spokes. Arredondo defines “aerodynamic shape” to mean the cross-section of the spoke in the axial direction has a length to thickness ratio of at least about two.

U.S. Pat. No. 7,114,784 to Ording et al. (Ording) discloses a disc type wheel with surface features designed to create turbulence in the boundary layer. The surface features can be uniform or random in place and size. Ording describes a disc shaped wheel which has no spokes. The patent directs the practitioner to use the surface features on the face of a disc type wheel. The Ording reference does not apply the disclosed surface features to spokes.

U.S. Pat. No. 6,431,498 to Watts, et al. (Watts) discloses a plurality of aerodynamic protrusions spaced laterally along the leading edge of an airplane wing. These include: aircraft, including stators, rotors, fans and various appendages; watercraft, including rudders, conning towers, sailboat keels, sailboat masts, submarine dive planes; and land vehicles including car spoilers.

In A whale of a tale an article published May 14, 2007, Tyler Hamilton described the use of scalloped edges for wind-turbine blades. Mimicking Humpback Whale Flippers May Improve Airplane Wing Design, published in June of 2004, discloses the use of scalloped edges on airplanes.

A Journal of Aircraft article by David S. Miklosovic, Mark M. Murray, & Laurens E. Howle, Experimental Evaluation of Sinusoidal Leading Edges, Journal of Aircraft, Vol. 44, No. 4, 1404-1407, (2007), studied the mechanism by which the scalloped edge provides benefit. The authors report a study on two wings, one in which half of the span was scalloped and the other half tapered, and the other wing had scallops covering the full span of the wing. Scallops were reported to have a largely 3-D benefit inducing vortical flow. In the full-span wing this vortical flow triggered early separation but in the half-span wing, effectiveness was enhanced because the span-wise stall progression was inhibited thereby extending the operating parameters with little penalty on performance. Performance of an object bounded on both ends, such as a spoke of a bicycle wheel, was not studied.

Accordingly, it is a goal of the present invention to improve upon the aerodynamic nature of a bicycle wheel. It is also an objective of the present invention to improve upon traditional airfoil spoke designs of a bicycle wheel by modifying the spokes. An additional objective of this invention is to improve the aerodynamics of a bicycle wheel without increasing the weight of the wheel. The aerodynamic protrusions can provide two-dimensional and three-dimensional aerodynamic benefits.

### DESCRIPTION OF DRAWINGS

FIG. 1 is a side perspective view of a bicycle wheel according to the present invention;

FIG. 2 is a leading edge view of a spoke according to the present invention;

FIG. 3 is a side plan view of the wheel;

FIG. 3A shows the wheel of FIG. 3 with the rim removed to show the spoke;

FIG. 4 is a side plan view of a spoke;

FIG. 5A is a side plan view of an alternative spoke design;

FIG. 5B is a side plan view of a still further alternative spoke design;

FIG. 6A illustrates an alternative configuration for the aerodynamic protrusions formed along the spoke;

FIG. 6B illustrates a still further alternative configuration for the aerodynamic protrusions formed along the spoke;

FIG. 7A illustrates a side plan view of a scallop shaped protrusion formed in accordance with a preferred embodiment of the present invention; and

FIG. 7B illustrates a top plan view of the scallop shaped protrusion illustrated in FIG. 7A.

### SUMMARY OF THE INVENTION

These and other features and objectives of the present invention will become apparent from the following detailed description considered in conjunction with the accompanying drawings. It is to be understood, however, that the drawings are designed as being illustrative only and not intended to define of the limits and scope of the invention.

### DETAILED DESCRIPTION OF THE INVENTION

A wheel according to the present invention includes a hub, rim, tire, and at least one spoke including at least one aerodynamic protrusion on the leading edge of the spoke. Preferably, the spoke is airfoil shaped with a plurality of aerodynamic protrusions along the leading edge of the airfoil. More preferably, the aerodynamic protrusions occur along the leading edge in a sinusoidal pattern with the space between the aerodynamic protrusions creating valleys.

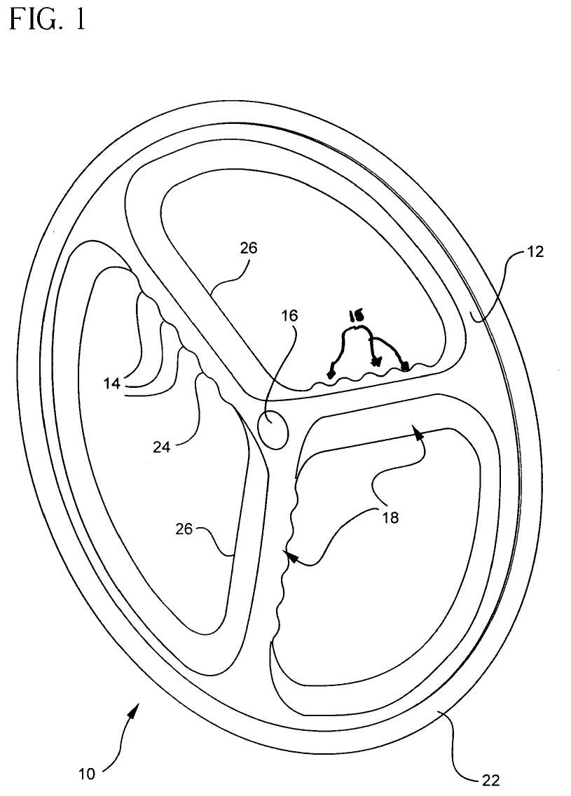

FIG. 1 illustrates a side perspective view of a bicycle wheel 10 according to the present invention. The wheel includes a hub 16 at its center, a rim 12 at its outer edge, a tire 22, and at least one spoke 18. The leading edge 24 of the spoke 18 exhibits aerodynamic protrusions 14 followed by valleys 15 in a sinusoidal pattern as described in greater detail below.

The tire 22 of the present invention is configured to be disposed on the outside of a rim 12 to provide traction between the road and the wheel 10. The rim 12 of the bicycle wheel 10 defines the outside portion of the wheel 10 to provide external support to the wheel 10. The rim 12 is further configured to receive the tire 22 and a first end spoke 18 on the inside of the rim 12.

The hub 16 is configured to operatively receive a second end of the at least one spoke 18 of the wheel 10. The hub 16 is further configured to define the center of the wheel, and is centrally disposed with respect to the rim 12. The hub 16 can be made from any suitable material.

The spoke 18 is configured to provide internal support to the wheel 10 and to support the hub 16. The spoke 18 is further configured to connect to the rim 12 at a first end and the hub 16 at a second end. The spoke 18 includes a leading edge 24, aerodynamic protrusions 14 and valleys 15. The leading edge 24 is the front portion of the spoke 18 and the portion that first contacts the air.

The spoke 18, hub 16, and rim 12 can be made of any type of material commonly used for wheels. For example, the spokes 18, hub 16 and rim 12 can be composed of carbon fiber, thermoplastic polymer, aluminum alloy, magnesium alloy, glass fiber, wood, steel, titanium, titanium alloy, combinations of these materials, or other known materials.

The tire 22 can be a tubular tire, clincher tire, or any other suitable bicycle tire. If it is a clincher tire, it can be made with steel wire, Kevlar® (para-aramid synthetic fiber), fabric, such as for example cotton, silk, polyamides or nylon cord, rubber, silicon, carbon black, any combination of these, or any other known clincher tire material. If the tire is a tubular tire, it can be made with fabric, such as for example cotton, silk, polyamides or nylon cord, rubber, silicon, carbon black, any combination of these, or any other known tubular tire material. The inner tube of the clincher or tubular tire can be made of latex rubber, butyl rubber, or any other suitable inner tube material.

The spoke 18, hub 16 and rim 12 can be hollow, partially filled, or solid. If the foregoing components are hollow or partially filled they can be filled with foam, vinyl polymer, or other commonly known fillers. The hub 16, rim 12, and spokes 18 can be cast from a solitary mold or can be separately formed. If separate, the spokes 18 join to both the rim 12 and the hub 16, and can be spaced at uniform angles from the hub 16. The spokes 18 can be made from the same materials as those of the wheel 10 or different materials. Preferably the hub 16, rim 12, and the spokes 18 are made from a single molding process and are monolithically formed.

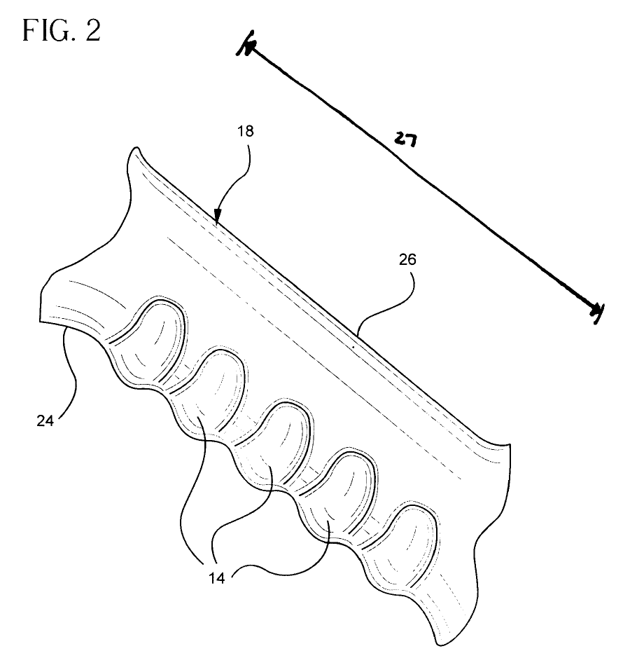

FIG. 2 is a leading edge view of the spoke 18. The spoke 18 has a length 27 and is preferably airfoil shaped with a leading edge 24 and a trailing edge 26. The spoke 18 includes aerodynamic protrusions 14 disposed along the leading edge 24 of the spoke 18. In between the aerodynamic protrusions 14 are the valleys 15.

The spoke 18 includes the leading edge 24 including at least one aerodynamic protrusion 14 and at least two corresponding valleys 15 to either side of the protrusion present in a sinusoidal pattern. Preferably the spoke includes multiple aerodynamic protrusions 14 and corresponding valleys 15 which are configured to reduce aerodynamic drag caused by both the spoke 18 and wheel 10 as they move through the surrounding air. The aerodynamic protrusions 14 can be formed along any portion of the spoke 18. They can occur, for example, along ¼, ½, ¾ the length of the leading edge 24 of the spoke 18; most preferably, the aerodynamic protrusions 14 cover the entire length of the leading edge 24 of the spoke 18. The aerodynamic protrusions 14 may be formed in a uniform pattern or a random pattern along the length of the leading edge 24 of the spoke 18; preferably they are formed in a uniform pattern.

In an alternate embodiment, the aerodynamic protrusions 14 may be formed along both edges leading edge 24 and trailing edge 26 of the spoke 18. The aerodynamic protrusions 14 can be spaced evenly along the leading edge 24 and create a smoothly varying, alternately forward and aft sweep along the leading edge 24 relative to the direction of air flow along the leading edge 24.

The size of a wheel 10 can vary depending on the height of the rider and other factors. Accordingly, the length 27 of the spoke 18, from the rim 12 to the hub 16 can also vary. Preferably, the spoke 18 is from about 4 inches to about 15 inches. More preferably, the spoke 18 is from about 6 inches to about 10 inches. Most preferably, the spoke 18 is about 7 inches in length 27.

The number of spokes 18 per wheel 10 can be from 1 to 40 spokes 18. Preferably it has from about 2 to about 20 spokes 18; more preferably from about 3 to about 5 spokes.

The spokes 18 of the bicycle wheel 10 can be at any location within the wheel 10. The spokes 18 can be made to be removable, like, for example, the spokes of the Ksyrium SL Premium wheel manufactured by Mavic. The spokes 18 can be adjustable, for example rotating on the axis between the hub 16 and the rim 12 so as to be angled as necessary for optimal aerodynamics based upon the wind conditions. Alternatively, the spokes 18 can be permanently directed and stationary in the preferred aerodynamic orientation. Preferably, the spokes 18 are connected within the bicycle wheel 10 at the rim 12 and the hub 16.

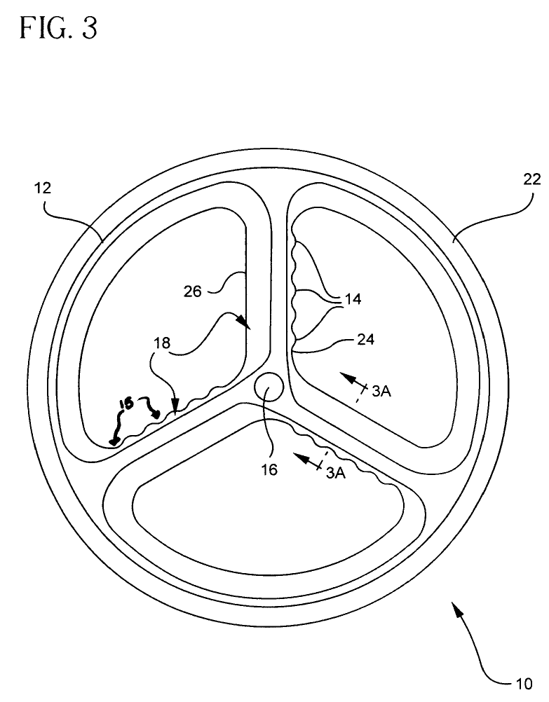

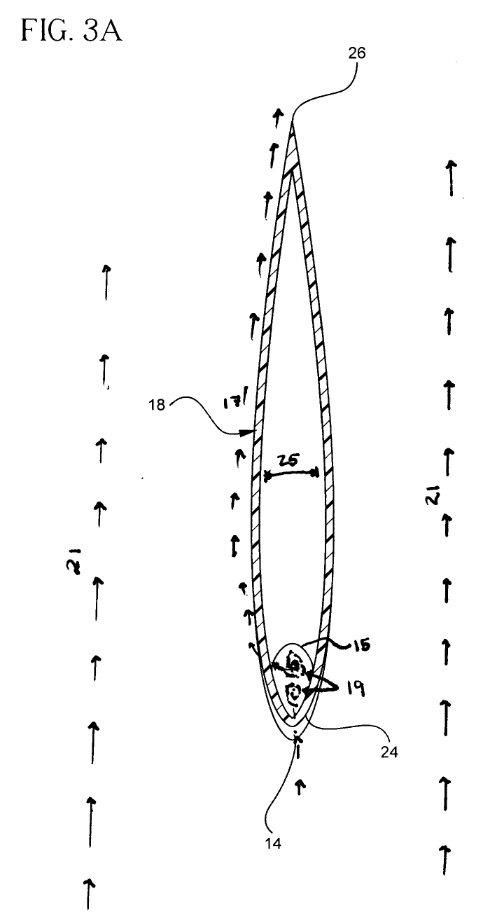

FIG. 3A is a side plan view of a wheel 10 and FIG. 3A shows the wheel of FIG. 3, with the rim 12 removed to expose the spoke 18. As stated above, the spoke 18 preferably has an airfoil shape including leading 24 and trailing 26 edges. Preferably, the aerodynamic protrusions 14 and corresponding valleys 15 repeat sinusoidally.

The spoke 18 as illustrated in FIG. 3A has a depth 25 and is shaped like an elongated tear drop. The trailing edge 26 ends in a sharp point and the leading edge 24 is wider and somewhat rounded. The leading edge 24 includes aerodynamic protrusions 14 and valleys 15 providing a repeatedly arced leading edge 24.

The protrusion 14 is configured to disrupt the airflow 17 along the leading edge 24 of the spoke 18. The disruption of airflow 17 caused by the protrusions 14 creates a plurality of airflows 17 and forces the airflows 17 into the valleys 15 to either side of the protrusion 14. The valleys 15 are configured to create and accelerate vortices 19 of air 17, causing the air 17 to roll around the leading edge 24 of the spoke 18. The protrusions 14 reduce the tendency of air to run down the width of the spoke 18 and fly off at the trailing edge 26, causing noise, instability and a loss of efficiency.

The trailing edge 26 is the side of the spoke opposite and parallel to the leading edge 26. The trailing edge 26 is configured to be sharply pointed and straight. The trailing edge 26 is further configured to allow vortices 19 of airflows 17 to move from the valleys 15 over the width of the spoke 18 and rejoin the primary air stream 21. The sharp straight trailing edge 26 is further configured so that the amount of airflow 17 on either side of the spoke 18 rejoins the main air stream 21 in an efficient and smooth manner without creating additional turbulence.

At the mid-point between the leading edge 24 and trailing edge 26 of the spoke 18, the depth 25 of the spoke 18 is the distance between the two sides of the spoke 18 from about 0.1 to about 1.50 inches. Preferably the depth 25 is from about 0.25 inches to about 1.0 inches. More preferably, the depth 25 is from about 0.5 inches to about 0.8 inches. Most preferably, the depth 25 is about 0.75 inches.

In operation, the wheel 10 described above can be utilized on any wheeled transportation which makes use of wheels having spokes. The wheel 10 is preferably applied to both wheels of a racing bicycle. Use of the wheel 10 having spokes 18 with aerodynamic protrusions 14 reduces the drag caused by both the spokes 18 and the wheel 10. The spoke 18 formed with aerodynamic protrusions 14 enhances the efficiency of the wheel 10. This enhanced wheel efficiency leads to an increase in the efficiency of the bicycle to which it is applied. Accordingly, a rider can expend less energy to maintain the same speed or the same amount of energy and attain a greater speed.

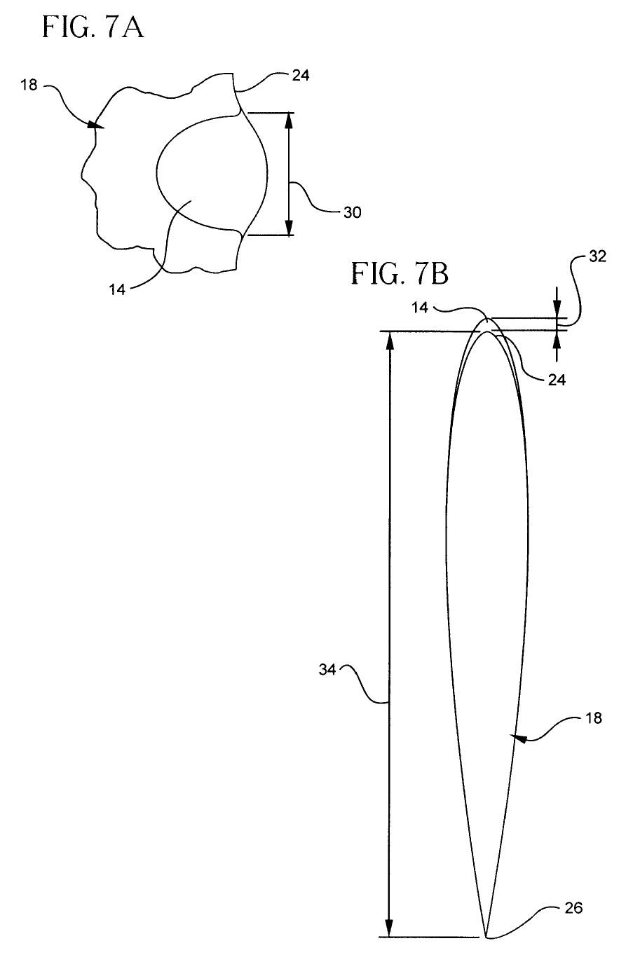

FIGS. 7A and 7B illustrate a repeatedly arced or scallop-shaped protrusion 14 and antipodean arced valley 15. The aerodynamic scallop-shaped protrusion 14 and antipodean valley 15 may be configured to provide aerodynamic benefit to the spoke 18. The aerodynamic protrusion 14 has a height 32 and width 30. The spoke 18 of wheel 10 has a chord 34.

The chord 34 of the spoke 18 can vary from about 0.25 to about 5 inches. Preferably, the chord 34 is from about 0.5 to about 4 inches. More preferably, the chord 34 is from about 1 inch to about 3.5 inches. Most preferably, the chord 34 is about 3 inches. The chord 34 is measured from the leading edge 24 to the trailing edge 26.

The height 32 of each aerodynamic protrusion 14 is a percentage of the chord 34 of the spoke 18. The height 32 can be from about 0.25% of chord 34 to about 100% of the chord 34. Preferably, the height 32 of the aerodynamic protrusion 14 is from about 0.75% of the chord 34 to about 50% of chord 34. More preferably, the aerodynamic protrusion 14 is from about 2% of the chord 34 to about 10% of the chord 34. For a typical adult racing bicycle the height 32 of the aerodynamic protrusion 14 is preferably about 4% of chord 34. Furthermore, the height 32 of each aerodynamic protrusion 14 can be independent of the height 32 of other aerodynamic protrusions 14 along the spoke 18. Preferably, the height 32 of all aerodynamic protrusions 14 is the same.

In operation, when applying these percentages to the spoke 18 and aerodynamic protrusions 14 described a calculation may, optionally, be applied. For example, The Journal of Aircraft article (David S. Miklosovic, Mark M. Murray, & Laurens E. Howle, Experimental Evaluation of Sinusoidal Leading Edges, Journal of Aircraft, Vol. 44, No. 4, 1404-1407, (2007)) provides an equation which is used, for example, to calculate the width of the spoke 18 (x) at any given point (y) along the leading edge 24 of the scalloped aerodynamic protrusions 14 based on the chord 34(c).

x_{LE}=0.04c*cos(2πy/0.41c)

As stated above, preferably, the scallop-shaped aerodynamic protrusions 14 repeat sinusoidally, so in the equation the cosine function is used. The term 0.41c represents the period of the wave, which is the length of each aerodynamic protrusion 14. The term 0.04c represents the amplitude of the wave, which is the height 32 of each aerodynamic protrusion 14. The symbol c represents the chord 34 of the spoke 18, from leading edge 24 to the trailing edge 26.

Applying the preferred dimensions to the spoke 18 as described above, to the equation, the height 32 of each aerodynamic protrusion 14 is 0.04* chord 34, or 0.04*3 inches=0.12 inches. The width 30 or period of each protrusion 14 is 0.41*chord 34, or 0.41*3 inches=1.23 inches. At the preferred spoke 18 length, about 7 inches, would have: 7/1.23=5.69 aerodynamic protrusions 14. Only whole aerodynamic protrusions 14 would be used. Therefore, this embodiment would have 5 aerodynamic protrusions 14.

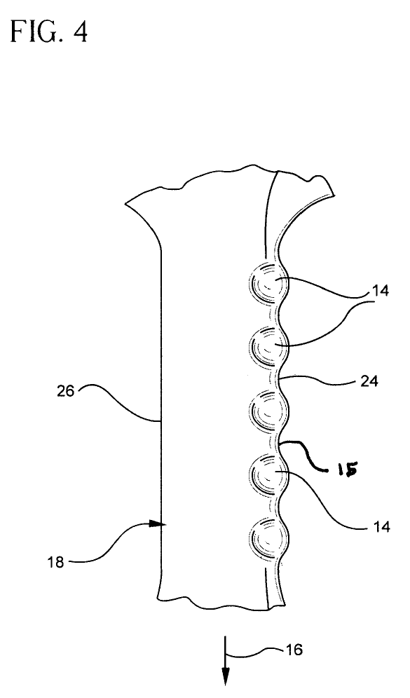

FIG. 4 illustrates a side plan view illustrating a spoke 18, with aerodynamic protrusions 14 formed in accordance with the present invention.

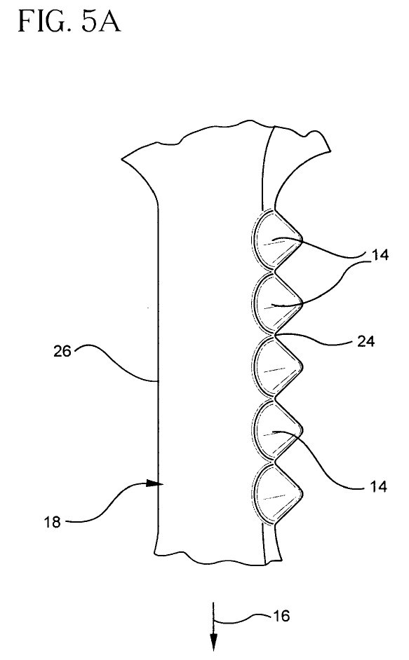

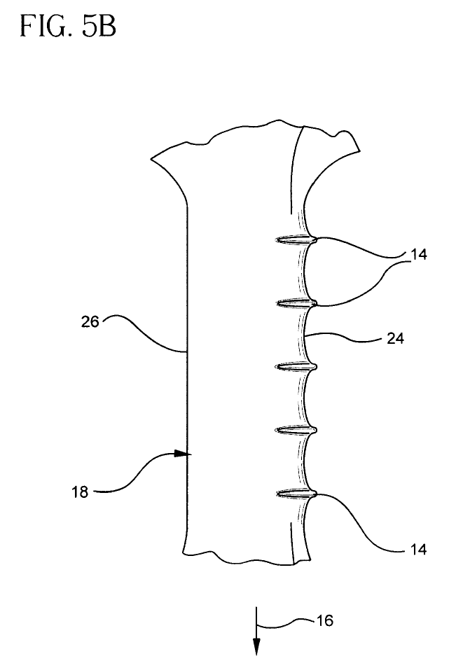

FIGS. 5A and 5B illustrate various alternative shapes suitable for the aerodynamic protrusions 14. The aerodynamic protrusions 14 can be any shape that will provide the desired effect. For example, the aerodynamic protrusions 14 can be circular, spherical, conical, triangular, cube-shaped, rectangular, rhomboid, wave-like, scallop-shaped, etc. Any combination of shapes can also be used. Preferably the aerodynamic protrusions 14 form a scallop-shaped surface along the leading edge of the spoke.

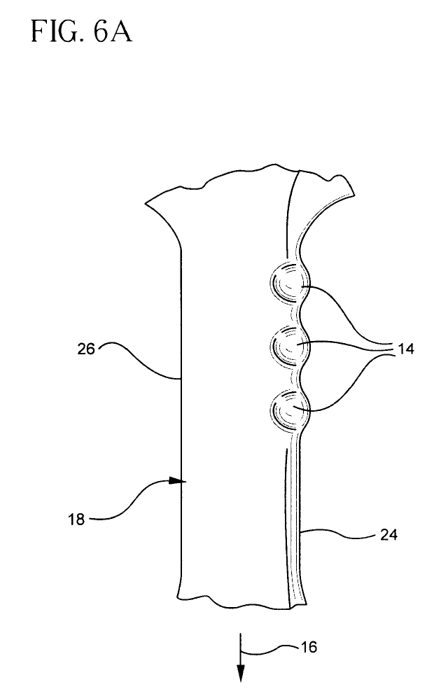

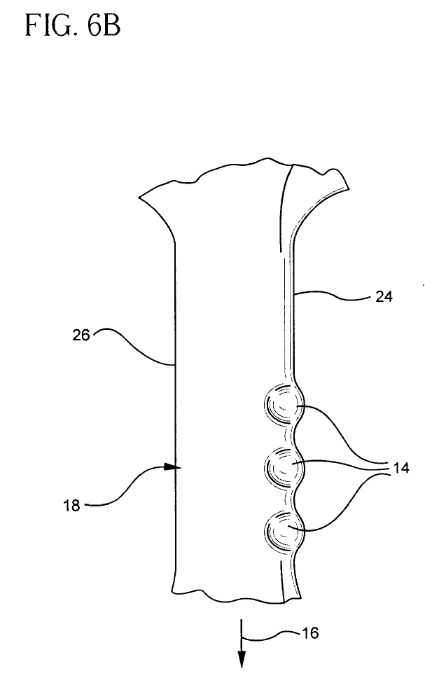

FIGS. 6A and 6B illustrate of various alternative configurations for the aerodynamic protrusions 14 along the spoke 18. The camber of the aerodynamic protrusions 14 can be consistent across the spoke 18 or can vary, for example, increasing camber toward the hub 16 or decreasing camber from the hub 16. Another pattern, for example, would be for the camber to decrease until the midpoint of the spoke 18 and then increase camber toward the hub 16 and the rim 12 or the camber can increase until the midpoint and decrease toward the hub 16 and the rim 12. Preferably, the aerodynamic protrusions 14 and the associated valleys 15 are uniform in camber along the length of the spoke 18. Most preferably the aerodynamic protrusions 14 create an undulating curve along the length of the spoke 18.

While primarily directed to racing bicycle wheels, in operation the wheel 10 can be utilized on bicycles, for example: adult bicycles, children's bicycles, bicycle training wheels, tandem bicycles, recumbent bicycles, lowriders, half bicycles, racing bicycles, dirt bikes, unicycles, tricycles, quadracycles, mountain bikes, touring bicycles, cruiser bicycles, velocipedes, and any other type of bicycle. The wheel can also be used, for example, on motor bikes, wheelchairs, racing wheelchairs, or motorcycles. Although the wheels 10 of the invention may be replace only one wheel of a bicycle, preferably, the wheels 10 of replace all currently used wheels of the bicycle.

While there have been described what are presently believed to be the preferred embodiments of the invention, those skilled in the art will appreciate that further changes and modifications can be made to the present invention, and it is intended to include such changes and modifications as coming within the scope of the invention.

What is claimed is:

1. A wheel comprising:
a rim configured to receive a tire;
a hub disposed centrally in relation to the rim;
at least one spoke extending from said hub to said rim, said at least one spoke having a leading edge that includes at least two aerodynamic protrusions and at least one valley therebetween.

2. The wheel according to claim 1, wherein said at least two aerodynamic protrusions are scallop-shaped.

3. The wheel according to claim 1, wherein said at least one spoke further includes a trailing edge.

4. The wheel according to claim 1, wherein said wheel is a bicycle wheel.

5. The wheel according to claim 1 wherein said at least two aerodynamic protrusions and said at least one valley are provided along the entire length of the leading edge.

6. The wheel according to claim 3, wherein said trailing edge is sharply pointed along its length.

7. The wheel according to claim 1, wherein the leading edge includes from about 2 to about 25 aerodynamic protrusions.

8. The wheel according to claim 7, wherein the leading edge includes from about 3 to about 10 aerodynamic protrusions.

9. The wheel according to claim 1, wherein the wheel has three spokes.

10. The wheel according to claim 9, wherein at least two of said three spokes includes at least two aerodynamic protrusions and at least one valley.

11. The wheel according to claim 9, wherein each of said three spokes includes at least two aerodynamic protrusions and at least one valley.

12. A method of reducing aerodynamic drag on a wheel, the method comprising:
disrupting airflow around an aerodynamic protrusion disposed on a leading edge of a spoke of the wheel into a plurality of airflows forming at least a first vortex about a first valley associated with the protrusion and at least a second vortex about a second valley associated with the protrusion; and
joining the plurality of airflows at a trailing edge of the spoke such that
said disrupting and joining of said airflows reduces aerodynamic drag on the wheel.

13. The method according to claim 12, wherein the valley is antipode of the aerodynamic protrusion.

14. The method according to claim 13, where the plurality of airflows at the trailing edge of the spoke join a primary air stream without creating substantial additional turbulence.
